(19) United States
(12) Patent Application Publication
(10) Pub. No.: US 2013/0167096 A1
(43) Pub. Date: Jun. 27, 2013

(54) LOCATION AND TIMING WINDOW BASED DECOUPLING CAPACITOR EVAULATION TOOL AND METHOD

(71) Applicants: Martin Fennell, Iver Heath (GB); James Monthie, Fulton, MD (US); Iain Stickland, Yateley (GB)

(72) Inventors: Martin Fennell, Iver Heath (GB); James Monthie, Fulton, MD (US); Iain Stickland, Yateley (GB)

(73) Assignee: LSI Corporation, Milpitas, CA (US)

(21) Appl. No.: 13/334,542

(22) Filed: Dec. 22, 2011

(51) Int. Cl. G06F 17/50

(52) U.S. Cl. 716/108

(57) ABSTRACT

A method of designing an integrated circuit includes receiving a placement database of logic devices of an electronic device design that includes first and second logic devices. The method further includes determining a first timing window associated with a first state transition of the first logic device, and a second timing window associated with a second state transition of the second logic device. In the event that the first and second timing windows overlap, the placement database is modified, thereby reducing interaction of the first and second logic devices.

### TECHNICAL FIELD

This application is directed, in general, to systems and methods for electronic design automation.

### BACKGROUND

An integrated circuit (IC) typically includes numerous connections between electrical components. These connections are often designed with the assistance of an electronic design automation (EDA) tool. The EDA tool typically includes software instructions operating on an engineering workstation to automate and/or streamline various tasks associated with design of the IC. A design engineer typically manipulates modular design cells from a cell library to build up a design database. An autorouter within the EDA tool determines the connection paths between the design cells. When the design layout is complete, the layout data are used in a pattern generation (PG) step that generates pattern data suitable to produce a set of pattern masks used in photolithographic steps of an IC manufacturing process.

Before the PG step, the designer may perform a dynamic gate-level simulation of IC design and estimate various performance parameters, such as power consumption and timing robustness. If the estimates are deficient with respect to one or more design objectives, the designer may revise the design database to correct the source of the deficiency to meet the relevant design objective. The designer may again perform a gate-level simulation to determine if the revised design meets the design objective. This revision cycle consumes significant time, as the gate-level simulation of even a moderately complex IC design may be quite time-intensive.

### SUMMARY

One aspect provides a method of designing an integrated circuit. The method includes receiving a placement database of logic devices of an electronic device design, including first and second logic devices. The method further includes determining a first timing window associated with a first state transition of the first logic device, and a second timing window associated with a second state transition of the second logic device. In the event that the first and second timing windows overlap, the placement database is modified, thereby reducing interaction of the first and second logic devices.

Another aspect provides a computer program product comprising a computer readable medium. The medium has a series of operating instructions embodied therein that is adapted to be executed implement a method of designing an integrated circuit. The method includes receiving a placement database of logic devices of an electronic device design, including first and second logic devices. The method further includes determining a first timing window associated with a first state transition of the first logic device, and a second timing window associated with a second state transition of the second logic device. In the event that the first and second timing windows overlap, placement database is modified, thereby reducing interaction of the first and second logic devices.

Yet another embodiment provides an electronic design automation system. The system includes a hazard detection module and a correction module. The hazard detection module is configured to execute a computer-executed algorithm to determine from a placement database of logic devices of an electronic design a first timing window associated with a first state transition of a first logic device, and a second timing window associated with a second state transition of a second logic device. The correction module is configured to modify the placement database in the event that the first and second timing windows overlap, thereby reducing interaction of the first and second logic devices.

### BRIEF DESCRIPTION

Reference is now made to the following descriptions taken in conjunction with the accompanying drawings, in which:

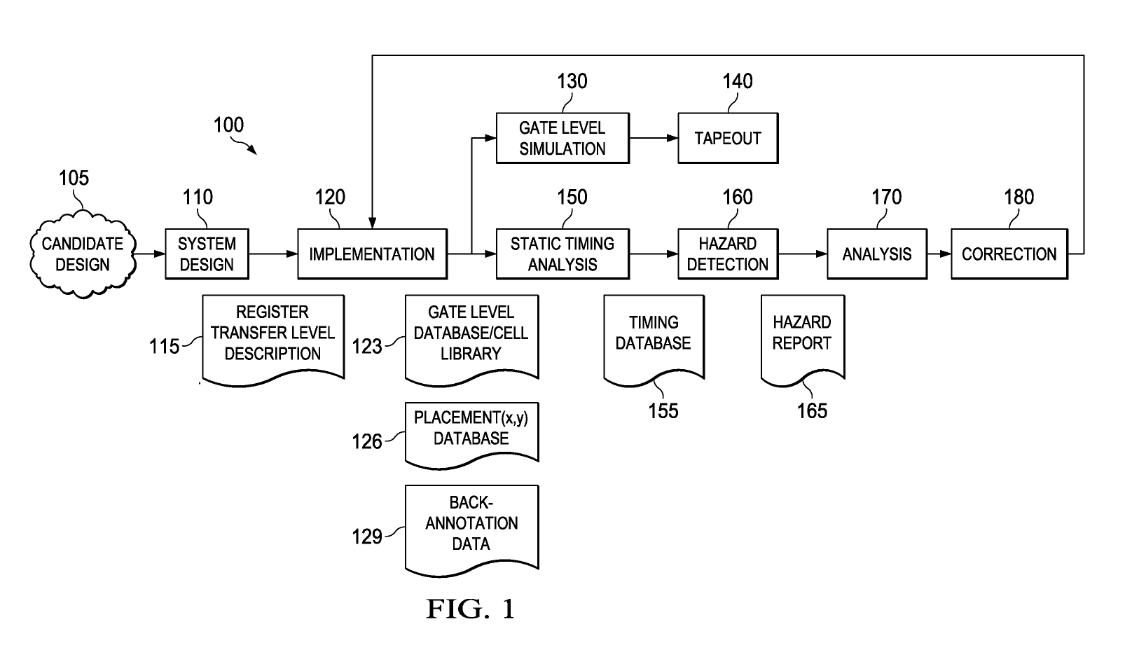

FIG. 1 illustrates a method, e.g. of designing an IC, according to one embodiment, including a static timing analysis module and a hazard detection module;

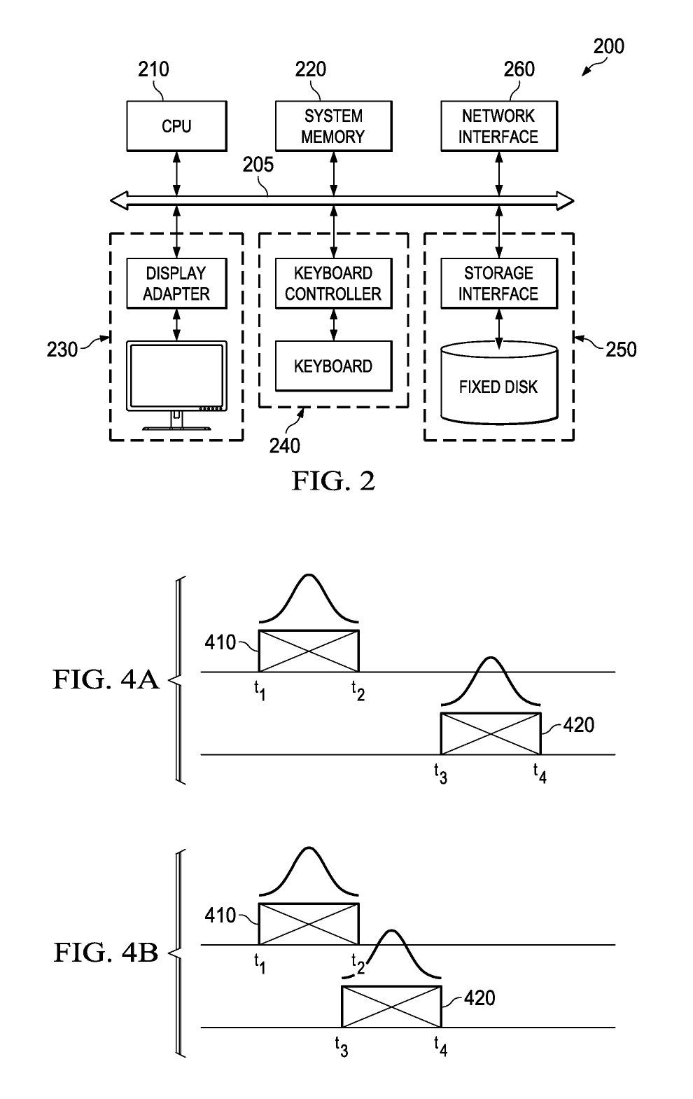

FIG. 2 depicts a block diagram of a computer system suitable for implementing the method of FIG. 1;

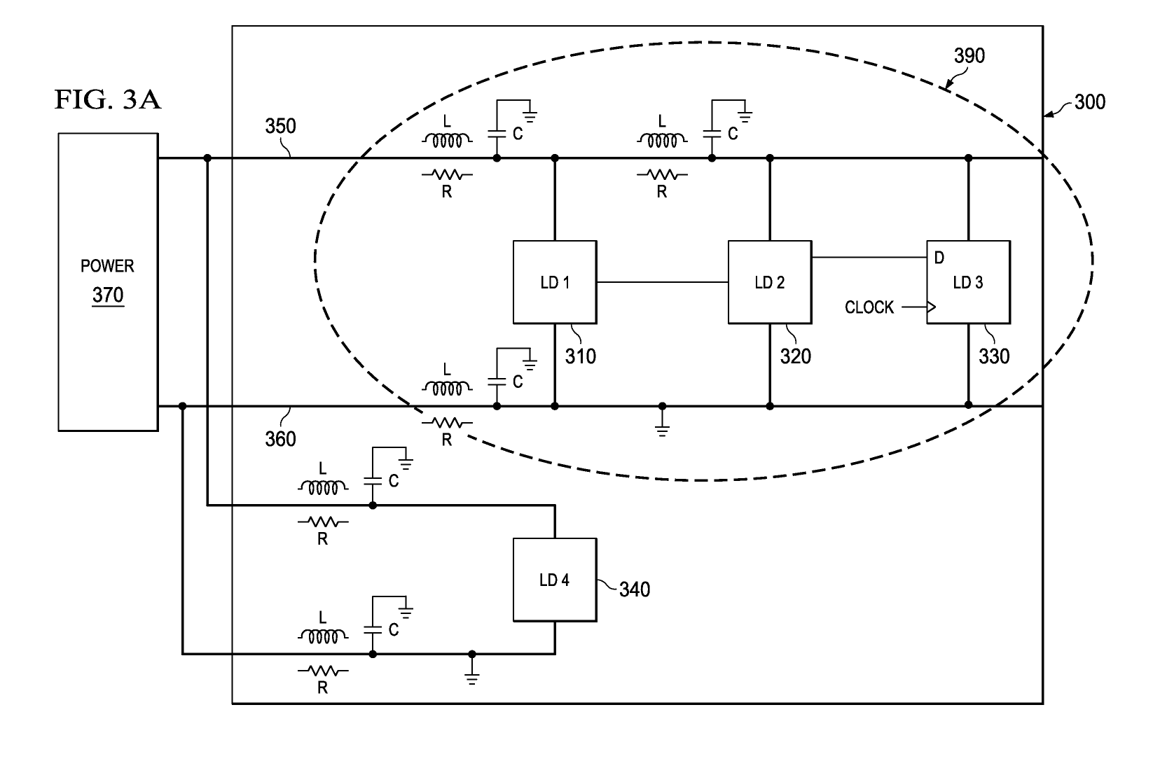

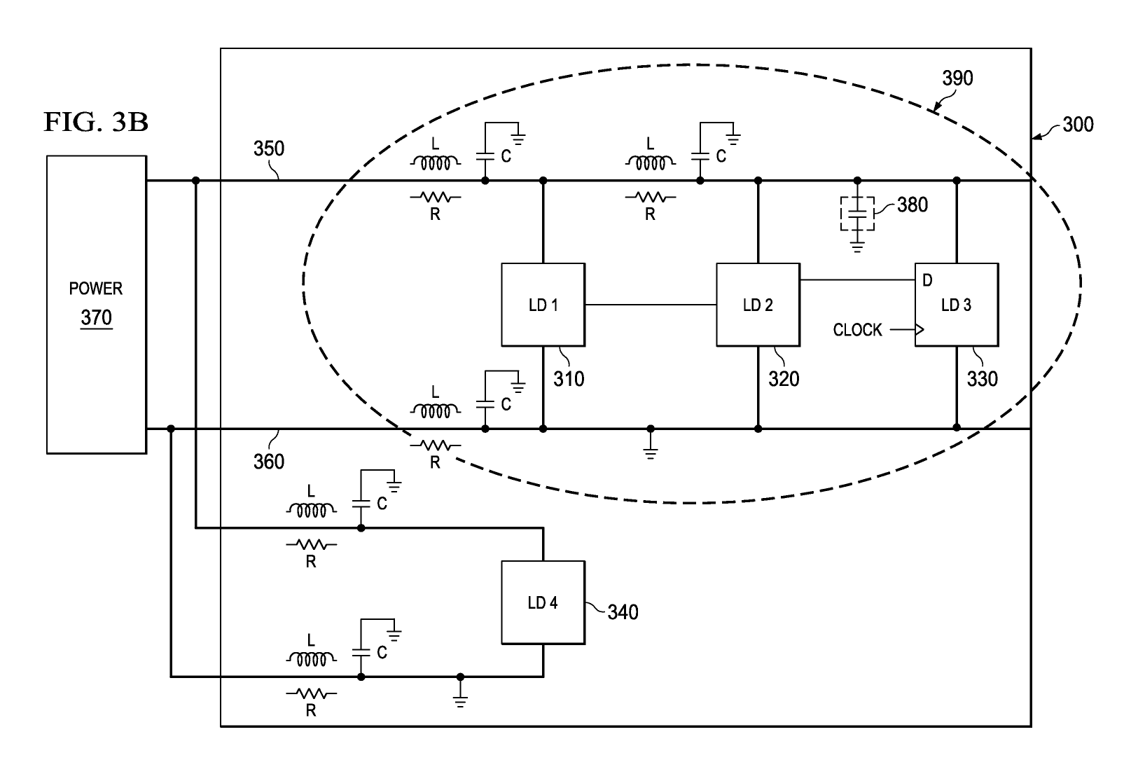

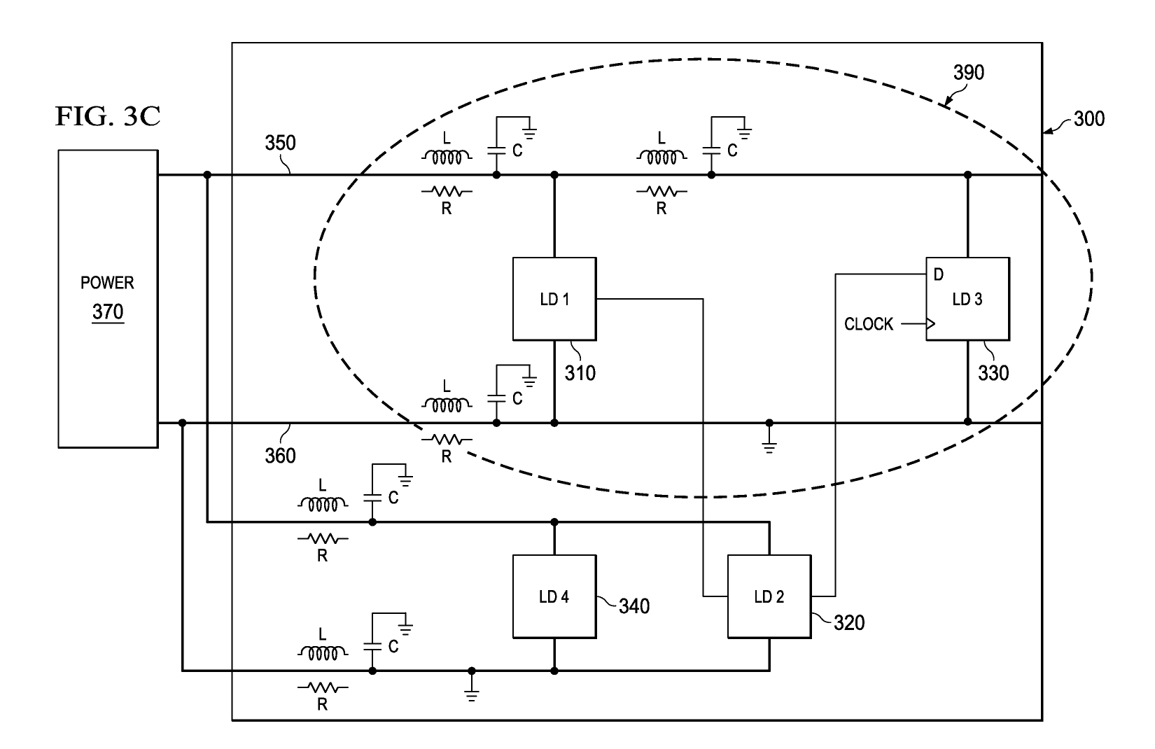

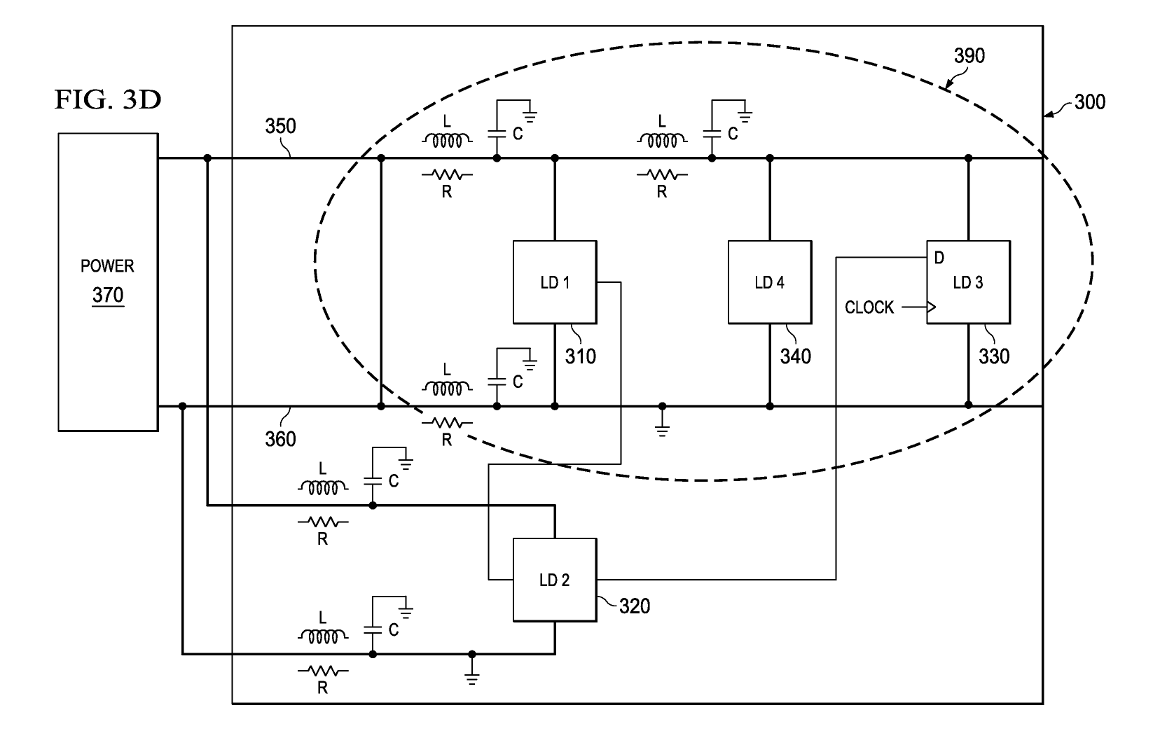

FIG. 3A-3D schematically illustrate in illustrative embodiments configurations of logic devices, power supply rails and parasitic elements;

FIGS. 4A and 4B each illustrate a timing window associated with each of two logic devices of FIG. 3, wherein the timing windows represent a range of time within which a signal transition may occur, and wherein the timing windows overlap in FIG. 4B but do not overlap in FIG. 4A;

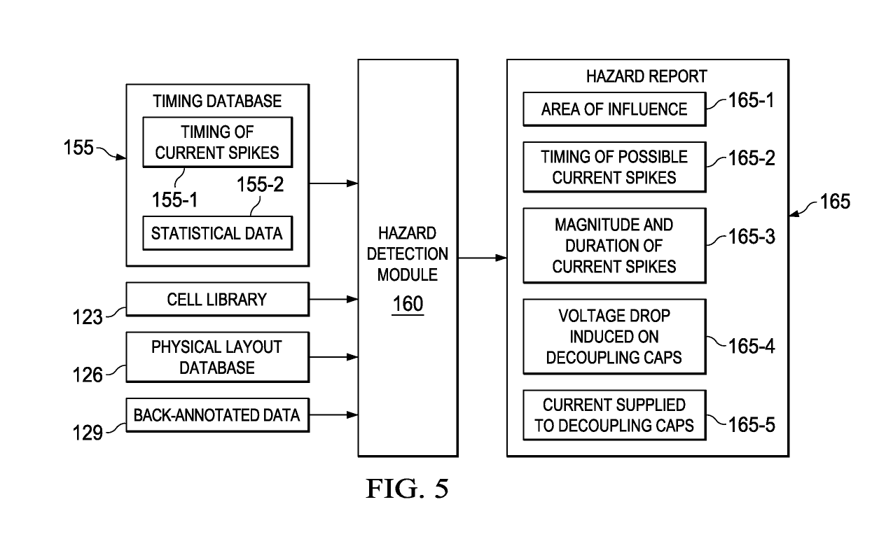

FIG. 5 illustrates aspects of an algorithm configured to execute on a computing platform to determine from the timing windows of FIGS. 4A and 4B a database of coupling hazards; and

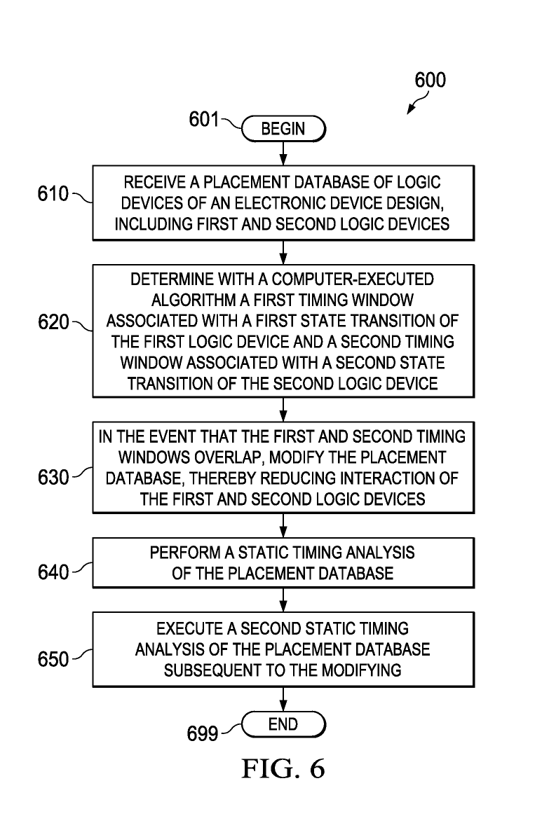

FIG. 6 illustrates one embodiment of a method of designing an integrated circuit, e.g. implementing aspects described by FIGS. 1, 3A-D, 4A-B and 5.

### DETAILED DESCRIPTION

Embodiments of methods and systems described herein provide an innovative technique using static timing analysis (STA) to estimate the effectiveness of power supply decoupling in an integrated circuit design earlier in the design cycle than done in conventional practice. Power supply decoupling is typically accomplished using power-decoupling elements in the circuit design. Such power decoupling elements are typically primarily capacitive, and may be referred to herein without limitation as decoupling capacitors, or decaps.

Because of the distributed nature of parasitic electrical effects such as resistance, capacitance, and inductance, the precise placement location of a decap in an IC design may have a significant effect on the sufficiency of that decap to filter electrical (e.g. current and/or voltage) noise from a power supply mesh in the circuit. While the experience of the designer is an important aspect of circuit layout, significant uncertainty often remains about the effectiveness of the decoupling. Typically, the designer performs a dynamic gate-level simulation of the design, including closed timing, to obtain data on the decoupling, and circuit locations with insufficient decoupling are identified. The designer may then modify the design and repeat the process until all areas of concern have been resolved. However, repeated gate-level simulations are costly in terms of time and computational resources.

Embodiments described herein and otherwise within the scope of the disclosure provide design feedback to the designer earlier in the design process, e.g. prior to dynamic gate-level simulation. By identifying regions of the design with insufficient coupling, without performing a full closed-timing dynamic analysis, embodiments of the invention may bypass costly gate-level simulations while providing guidance to the designer that is sufficient to address many power-mesh bypass issues. The device design cycle time may thereby be reduced, bringing the design to market earlier while significantly reducing design costs.

FIG. 1 presents without limitation a system 100 for designing an electronic device, e.g. an integrated circuit. The system 100 operates to produce a physical IC layout from a candidate design 105, which may initially be defined at a highly abstract level. In a system design module 110 the candidate design 105 is rendered in a hardware description language (HDL) such as register transfer level (RTL) format, e.g. implemented in Verilog® or VHDL languages. Those skilled in the art will appreciate that in RTL, behavior of a candidate design is defined in terms of the flow of signals (or transfer of data) between hardware registers, and the logical operations performed on those signals. Often the HDL description is produced by a design engineer at a design workstation. The system design module 110 produces as output an HDL description file, e.g. an RTL file 115 in the illustrated embodiment.

An implementation module 120 receives the RTL file 115 and operates thereon to render a gate level description of the candidate design 105. The module 120 may be performed on an EPA tool as described herein. The module 120 produces a gate-level design file, or database, 123 and a placement database 126. The gate-level database 123 includes gate cell descriptions that characterize the electrical behavior of the various gates in the design, e.g. a cell library. The placement database 126 includes, e.g. the placement location for each cell within the design 105, e.g. a physical layout of the cells (e.g. gates) in the design 105. The module 120 also produces a back-annotation database 129. The database 129 includes back-annotation data, e.g. parametric data determined from a physical implementation of the design 105 that affects the timing of signals in the simulation space. The back-annotation data may include, e.g. input ramptime, output loading and gate-delays for functional cells in the candidate design 105, and interconnection impedance characteristics. These data may be generated, e.g. by an EPA tool such as described below.

In conventional practice, a gate-level simulation module 130 performs a dynamic simulation of the electrical and temporal behavior of the design 105. The results of this analysis are conventionally used to identify functional errors and timing conflicts. As described previously, this step is typically very time-consuming, thereby requiring substantial time and computing resources in the design cycle. This issue is compounded when revisions of the design 105 are needed to correct the functional and timing errors identified by the simulation. When the design is fully qualified, the system 100 executes a tapeout module 140 in which pattern generation data are produced for mask fabrication.

In contrast to conventional practice, the system 100 provides a static timing analysis (STA) module 150 following the implementation module. The STA module 150, described in greater detail below, is configured to execute an STA of the design 105 as described by the databases 123, 126 and 129. As appreciated by those skilled in the pertinent art, STA uses a constraints-based approach that calculates timing margin for possible timing paths in the design and runs much faster than a full-timing gate-level simulation. The determines various timing parameters within the design 105, e.g. arrival times of signals at various gate inputs. The timing data may be stored in a timing database 155. As discussed further below, these timing data may be advantageously exploited to provide feedback on potential power supply coupling hazards in the design.

A hazard detection module 160, also discussed further below, receives the database 155 and determines the existence of any power supply coupling hazards in the design 105. The module 160 may produce a hazard report 165 documenting the identified hazards for appropriate mitigation.

In an analysis module 170 the hazard report is analyzed for possible resolution of the hazards. This step may be performed by the designer, or may be automated when identified hazards do not require designer judgment to resolve. Resolution of the hazards may include one or more changes to the design 105 in a correction module 180. Such changes may include, e.g. increasing decoupling capacitance in one or more locations, moving interacting logic devices, or swapping interacting logic devices with other non-interacting logic devices. This aspect is discussed further below.

The functions of the system 100 described herein may be modules or portions of modules (e.g., software, firmware or hardware modules). For example, although the described embodiment includes software modules and/or includes manually entered user commands, the various example modules may be application specific hardware modules. The software modules discussed herein may include script, batch or other executable files, or combinations and/or portions of such files. The software modules may include a computer program or subroutines thereof encoded on computer-readable media.

Additionally, those skilled in the art will recognize that the boundaries between modules are merely illustrative and alternative embodiments may merge modules or impose an alternative decomposition of functionality of modules. For example, the modules discussed herein may be decomposed into sub-modules to be executed as multiple computer processes and, optionally, on multiple computers. Moreover, alternative embodiments may combine multiple instances of a particular module or sub-module. Furthermore, those skilled in the art will recognize that the functions described in example embodiments are for illustration only. Operations may be combined or the functionality of the functions may be distributed in additional functions in accordance with the invention.

Alternatively, such actions may be embodied in the structure of circuitry that implements such functionality, such as the micro-code of a complex instruction set computer (CISC) firmware programmed into programmable or erasable/programmable devices, the configuration of a field-programmable gate array (FPGA), the design of a gate array or full-custom application-specific integrated circuit (ASIC), or the like.

Each of the blocks of the flow diagram may be executed by a module (e.g., a software module) or a portion of a module or a computer system user using, for example, a computer system or design workstation such as an electronic design automation system 200, described below. Thus, the above-described system 100, the functions thereof and modules therefore may be executed on a computer system configured to execute the functions of the method and/or may be executed from computer-readable media. The system 100 or portions thereof may be embodied in a machine-readable and/or computer-readable medium for configuring a computer system execute the method. Thus, the software modules may be stored within and/or transmitted to a computer system memory to configure the computer system to perform the functions of the module.

Such a computer system normally processes information according to a program (a list of internally stored instructions such as a particular application program and/or an operating system) and produces resultant output information via I/O devices. A computer process typically includes an executing (running) program or portion of a program, current program values and state information and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

The software modules described herein may be received by such a computer system, for example, from computer readable media. The computer readable media may be permanently, removably or remotely coupled to the computer system. The computer readable media may non-exclusively include, for example, any number of the following: magnetic storage media including disk and tape storage media, optical storage media such as compact disk media (e.g., CD-ROM, CD-R, etc.) and digital video disk storage media, nonvolatile memory storage memory including semiconductor-based memory units such as flash memory, EEPROM, EPROM, ROM or application-specific integrated circuits (ASICs), volatile storage media including registers, buffers or caches, main memory, RAM and the like, and data transmission media including computer network, point-to-point telecommunication and carrier wave transmission media. In a UNIX-based embodiment, the software modules may be embodied in a file that may be a device, a terminal, a local or remote file, a socket, a network connection, a signal, or other expedient of communication or state change. Other new and various types of computer-readable media may be used to store and/or transmit the software modules discussed herein.

FIG. 2 depicts a block diagram of an electronic design automation system 200 suitable for implementing embodiments of the invention, e.g. a computer system. While not limited to any particular type of computer system, it may be preferable that the system 200 be capable of implementing a design and verification tool set such as the Cadence® System Development Suite, the Synopsys® Galaxy® Design Platform, or a similar development tool.

The system 200 includes a bus 205 that interconnects major subsystems of the system 200. The number and type of subsystems connected to the bus 205 is not limited to any particular number and type. In an illustrative and nonlimiting embodiment the system 200 includes a central processor unit (CPU) 210, a system memory 220, a display 230 and display adapter, a keyboard 240 and keyboard adapter, a fixed disk 250 and storage interface, and a network interface 260. In a nonlimiting embodiment the system 200 is a UNIX™ workstation.

The system 200 is configured to store operating instructions, e.g. on the fixed disk 250, that implement one or more embodiments of the disclosure. The instructions may be contained in, e.g. a standalone program or a subroutine. Additionally, operating instructions may be received by the CPU 210 via electronic signals received via the network interface 260.

In some cases the system 200 is optimized for circuit design activities, and may include the capability to visualize the candidate design 105, such as by an EDA tool. Without limitation, an example of such a platform and tool is a UNIX-based engineering workstation running the IC Compiler tool from Synopsys, Inc., Mountain View, Calif., USA. The various modules described herein may be linked to or invoked by other software operating on the system 200 by, e.g. a subroutine call or application programming interface (API).

FIG. 3A schematically illustrates without limitation a portion of an integrated circuit 300 described by the candidate design 105. The IC 300 includes logic devices 310, 320, 330 and 340. Each of the logic devices 310-340 may be any type of logic device, e.g. a gate, buffer, latch or memory cell. For the purpose of the present example and without limitation the logic devices 310 and 320 are taken to be gates, which may be referred to as gates 310 and 320, and the logic device 330 is taken to be a latch, which may be referred to as latch 330. The latch 330 latches data present at a data input D when a clock input provides a clock edge transition at the clock input. For the purpose of this discussion and the claims the latching of the data is a state transition of the latch 330. The gate 320 receives from the gate 310 an output signal, and the latch 330 receives from the gate 320 an output signal at a data input. Each of the gates 310 and 320 and the latch 330 are connected to power 350 and ground 360 rails of a power supply mesh. The power supply mesh is representative of any type of power mesh, including any number of voltages. The physical metal traces of the power mesh have associated parasitic electrical effects. For example, the traces have an associated resistance R per unit length, inductance L per unit length, and capacitance C per unit length. These effects are represented in FIG. 3A by appropriate lumped-element circuit symbols while recognizing that these effects are typically distributed effects.

The parasitic effects may result in electrically isolating the logic devices 310-330 from a power source 370. More specifically, the unit inductance L may cause the power mesh leads to act as low-pass filters. Thus, a high frequency power demand imposed on the power mesh by the gate 310 cannot be instantaneously satisfied by the power source 370. This typically results in a high-frequency (short duration) current and/or voltage transient in the power mesh e.g. a “current spike” localized near the gate 310. The power mesh transient may through to the outputs of other logic devices connected nearby to the mesh, e.g. the gate 320.

In some cases the latch 330 may be sensitive to the effect of power mesh transients on the gate 320. For example, when a current spike on the mesh feeds through to the output of the gate 320, an incorrect value may be present at the latch 330 data input inside of a critical timing window of the latch 330. Thus an incorrect value may be latched into the latch 330 when the latch 330 is clocked. A critical timing window may include, e.g. a setup and hold time of a signal at the latch 330 data input. On the other hand, if the incorrect value arrives at the latch 330 input outside the critical timing window, there may be no affect on the data value by the latch 330. The possibility of a transient value that results from inadequate power mesh decoupling and causes a logic error may be referred to herein and in the claims as a “coupling hazard”. The actual occurrence of such an event may be referred to herein and in the claims as a “glitch”.

As used herein, the term “interaction” describes the simulated behavioral aspects of one logic device of an IC, e.g. the latch 330, that are dependent on or affected by another logic device of the IC, e.g. the gate 320. Such dependence may include, for example and without limitation, capacitive coupling between signal leads associated with the interacting logic devices, and/or a power supply glitch. Interaction may be primary, e.g. the first logic device acting directly the second logic device, or secondary, e.g. the first logic device affecting the second logic device via a third logic device.

Considering specifically the logic devices 320 and 330, the interaction therebetween may be reduced by one of the at least three following approaches. These approaches are illustrated by FIGS. 3B, 3C and 3D. First, the transient power demand in the immediate vicinity of one or both of the gates 310 and 320 may be substantially satisfied by one or more decoupling capacitors (decaps) located near one or both of the gates 310 and 320. In FIG. 3B a decap 380 is located near the power lead to the gate 320 for this purpose. Herein and in the claims, in this context “near” means that the gate 320 and the decap 380 are effectively conductively coupled through intervening power traces, e.g. are not inductively isolated from each other. Second, the gates 310 and 320 may be physically separated, e.g. located further apart in the physical layout to increase inductive isolation. FIG. 3C illustrates this approach, wherein the gate 320 is physically separated from the gate 310 and additionally is moved to different power supply And third, the gate 320 may be switched in the design with a third gate that is relatively unaffected by the transient by virtue of the timing of signals at the third gate's inputs. FIG. 3D illustrates this approach, wherein the gates 320 and 340 are swapped. The selection of mitigating action may be made after the analysis is completed in the analysis module 170, e.g. at the correction module 180.

To screen the design for coupling hazards, the hazard detection module 160 may determine whether a signal event at the gate 310 that may produce a mesh voltage transient may occur within a critical timing window of the latch 330. The occurrence of the transient and the clock edge at the latch 330 are typically temporally localized, but may have a significant temporal uncertainty. Therefore, the temporal correlation of these events may be described statistically.

FIG. 4A graphically illustrates without limitation a simplified case in which a timing window 410 describes a first state transition by the gate 310 that may produce a current spike on the power mesh. A timing window 420 describes a critical timing window within which the data input of the latch 330 must be stable to ensure stable operation. The window 410 indicates that the time of the first state transition may be as early as t₁, and as late as t₂. The window 420 indicates that the time at which the latch 330 data input must remain stable may be as early as t₃ and as late as t₄. Because t₃ is greater than t₂, it is expected that the latch 330 is insensitive to a transient of the output of the gate 320 caused by a current spike from the gate 310.

FIG. 4B graphically illustrates without limitation a simplified case in which the timing window 410 overlaps the critical timing window 420, e.g. t₂>t₃. This result indicates that the current spike caused by the gate 310 may occur, at least under some conditions, within the critical timing window of the latch 330. In other words, the overlap of the windows 410 and 420 indicates the existence of a potential coupling hazard. When such an overlap is detected, the hazard detection module 150 may record relevant parameters such as the identity of the gates 310, 320 and 330 and the relevant timing data for the windows 410 and 420 for later analysis in the analysis module 170.

Note that the determination of the existence of a coupling hazard may be made without determining an actual glitch will occur. The timing window 410 may be viewed as a measure of a probability distribution, or histogram, of the potential times that a current spike may be produced by the gate 310. Likewise the timing window 420 may be viewed as a measure of probability distribution of the potential times at which the latch 330 may be sensitive to the current spike produced by the gate 310. Thus the overlap of the timing windows 410 and 420 may be viewed as a measure of the risk of a glitch causing undesirable operation in the design 105.

The probability distribution within the timing windows 410, 420 need not be evenly distributed. For example, the probabilities may in some embodiments be modeled as normal distributions, e.g. Gaussian distributions, as indicated by the normal probability curves over the windows 410, 420. In such cases the times t₁ and t₂ may be taken as a multiple of the standard deviation σ associated with the normal distribution. For instance, t₁ and t₂ may be taken at the ±2σ or ±3σ limits on either side of the mean associated with the peak of a normal distribution that describes the window 410. In another example, the overlap of a first normal probability distributions associated with the window 410 and a second normal probability distributions associated with the window 420 may be disregarded when the probability associated with the overlap fails below a predefined probability threshold, e.g. about 5%. Modeling the windows 410, 420 as normal distributions may be advantageous, e.g. when it is determined that the normal distribution more accurately models real-world processes than does, e.g. an evenly distributed (flat) probability distribution.

in another example, t₁ and t₂ may be determined as the minimum and maximum times at which a current spike is calculated to occur in the STA. Similarly, t₃ and t₄ may be determined as the minimum and maximum times at which the latch 330 is sensitive a state change at the data input. In this example, a hazard may be strictly interpreted as any overlap between the windows 410, 420, without regard to the probability of a glitch actually occurring.

Even if it is determined that the output timing window of the gate 320 overlaps the critical input timing window of the latch 330, a conflict may not occur when the gate 320 and the latch 330 are sufficiently physically isolated. Referring back to FIG. 3A, the STA module 150 in some embodiments may determine a hazard zone 390 within which the logic device 310 is located. The hazard zone 390 is an area of the physical layout of the design 105 within which another logic device may be affected by a power rail transient produced by the logic device 310. The power rails supplying components of the physical layout outside the hazard zone 390 may be effectively isolated from the power rails within the hazard zone 390, e.g. when the path lengths of the physical traces therebetween are sufficiently long. The STA module 150 may determine the physical extent of the hazard zone 390 based on the cell library 123, the placement database 126 and the back-annotation database 129. In some cases the hazard zone 390 may be about centered on the logic device 310. The hazard zone 390 may be any shape, and in some cases may be about circular. The hazard detection module 160 may be configured to limit the scope of its hazard search to only those logic devices within a particular hazard zone, e.g. the hazard zone 390.

The hazard detection module 160 in some embodiments presumes that a glitch at the latch 330 can only occur when the gates 310 and 320 are both within the hazard zone 390 and the timing windows 410 and 420 overlap. Thus, for example, because the logic device 340 is outside the hazard zone 390 the hazard detection module 160 in various embodiments disregards any timing overlaps between the logic device 310 and the logic device 340 based on the hazard zone 390. Of course is possible that a hazard zone centered on the logic device 340 would include the logic device 310. In this case the hazard detection module 160 may screen the logic devices 310 and 340 for timing hazards from the point of view of the logic device 340.

FIG. 5 illustrates operation of the hazard detection module 160 in greater detail in one illustrative embodiment. The described functions of the hazard detection module 160 may be based on electrical relationships known to those of skill in the electrical arts, and implemented using conventional programming techniques.

As described previously, the hazard detection module 160 receives the timing database 155. The database 155 may include at least two classes of data. A first class 155-1 includes for each glitch identified by the STA module 150 timing information defining the possible times the associated current spike may occur. These data may include or be derived from, e.g. STA definitions and/or cell timing produced by the STA module 150. A second data class 155-2 includes for each identified glitch statistical information on the switching activity of nets and cells, e.g. how often particular cells cause a current spike, for different cases.

The hazard detection module 160 also receives the cell library 123 and the placement database 126. The cell library 123 includes electrical characteristics of the cells described therein, including characteristics such as magnitude and duration of switching currents associated with each cell type. The placement database 126 may include data that describes location of cells in the candidate design 105. The hazard detection module 160 may also receive the back-annotation database 129 as previously described.

The hazard detection module 160 operates on the input data and calculates various data pertinent to the designer. These data may be reported to the designer via the hazard report 165. The hazard report 165 may take any form, e.g. physical or electronic, and may be conveyed, e.g. by printout, email or electronic file. The hazard report 165 may include operational data regarding the logic devices 310, 320 and 330. Operational data may include, e.g. power dissipation, location, one or more timing windows, identity of any logic devices that are sensitive to the operation of the logic device 310, the identity of any logic devices to which the logic device 310 is sensitive, and the magnitude of a current or voltage transient which is caused by or experienced by the logic device 310. In some embodiments the hazard report may also be formatted for electronic manipulation by the analysis module 170 to perform automated resolution of some of the identified timing conflicts.

Area of influence data 165-1 describes for each glitch detected the lateral extent of the design layout affected by that the current spike associated with that glitch, e.g. the hazard zone 390. As described earlier, path inductance isolates the gates 310, 320 from the device power supply. Similarly, the path inductance isolates logic blocks from each other, so the effect of a current spike is typically limited to a determinable lateral extent about the logic block responsible for its generation. The designer or an automated routine in the analysis module 170 may advantageously use such information to limit remediation efforts to those circuit elements within he affected area.

Timing data 165-2 describes the timing, e.g. with respect to one or more system clocks and/or switching events of relevant logic blocks. These data may be derived from, e.g. the timing data 155-1 and the influence area data 165-1.

Magnitude and duration data 165-3 describe the magnitude and duration of some or all of the identified current spikes. These data may be limited to only those current spikes determined to be likely to affect system behavior. These data may be derived from, e.g. the cell library 123.

Voltage drop data 165-4 describe the voltage drop (or increase) produced on decoupling caps in the candidate design, e.g. the decap 380. Current data 165-5 describes the current flow to decaps in the candidate design, e.g. the decap 380. Such data are relevant, e.g. to determining the number and/or size of additional decaps that may placed in the candidate design to mitigate the effects of the current spikes, and whether the expected voltages exceed gate capacitor design rules.

FIG. 6 presents an illustrative method 600 according to one embodiment. The method 600 is described with reference to features described in FIGS. 1, 3A-3D, 4A-4B and 5, without limitation thereto. Steps of the method 600 may be performed in an order other than the illustrated order. The method 600 may include steps other than those shown, or some steps shown may not be performed. Moreover, aspects of the steps may be apportioned differently between steps without departing from the scope of the disclosure.

The method 600 begins with an entry step 601, which may be reached, e.g. from a calling routine or an API call. In a step 610, a placement database of logic devices of an electronic device design is received, e.g. the placement database 126. In a step 620 a computer-executed algorithm, e.g. within the hazard detection module 160, determines a first timing window, e.g. the timing window 410, associated with a first state transition of a first logic device in the placement database, e.g. the logic device 310, and a second timing window, e.g. the timing window 420, associated with a second state transition of a second logic device, e.g. the latch 330. In a step 630, in the event that the first and second timing windows overlap, the placement database modified, thereby reducing interaction of the first and second logic devices.

In the above-described embodiment of the method 600 the determining may include performing a static timing analysis of the placement database.

Any of the above-described embodiments of the method 600 may include a step 640 in which a static timing analysis of the placement database is executed after modifying the placement database. Embodiments of the method 600 may further include a step 650 in which a crate-level simulation of the electronic device design is executed after modifying the placement database.

In any of the above-described embodiments of the method 600, the modifying may include 1) adding a power supply decoupling capacitor near one or both of the first and second logic devices, and/or 2) increasing a placement distance between the first and second logic devices, and/or 3) swapping the first or second logic devices with a third logic device in the placement database.

In any of the above-described embodiments of the method 600, the algorithm may determine a coupling hazard risk zone that includes the first logic device. In such embodiments, the algorithm may determine a coupling hazard risk for the second logic device. Optionally the algorithm determines the coupling hazard risk zone that includes the first logic device only when the second logic device is located within the coupling hazard risk zone of the first logic device.

In any of the above-described embodiments of the method 600, the modifying may include changing a register transfer level description of the electronic device design.

Those skilled in the art which this application relates will appreciate that other and further additions, deletions, substitutions and modifications may be made to the described embodiments.

1. A method of designing an integrated circuit, comprising:
receiving a placement database of logic devices of an electronic device design, including first and second logic devices;
determining with a computer-executed algorithm a first timing window associated with a first state transition of said first logic device, and a second timing window associated with a second state transition of said second logic device; and
in the event that said first and second timing windows overlap, modifying said placement database thereby reducing interaction of said first and second logic devices, wherein said determining is performed by a processor.

2. The method as recited in claim 1, wherein said determining includes performing a static timing analysis of said placement database.

3. The method as recited in claim 1, further comprising executing a second static timing analysis of said placement database subsequent to said modifying.

4. The method as recited in claim 3, further comprising performing a gate-level simulation of said electronic device design after performing said second static timing analysis.

5. The method as recited in claim 1, wherein said modifying includes adding a power supply decoupling capacitor near one or both of said first and second logic devices.

6. The method as recited in claim 1, wherein said modifying includes increasing a placement distance between said first and second logic devices.

7. The method as recited in claim 1, wherein said modifying includes swapping said first or second logic devices with a third logic device in said placement database.

8. The method as recited in claim 1, wherein said algorithm determines a coupling hazard risk zone that includes said first logic device.

9. The method as recited in claim 8, wherein said algorithm determines a coupling hazard risk for said second logic device only when said second logic device is located within said coupling hazard risk zone of said first logic device.

10. The method as recited in claim 1, wherein said modifying includes changing a register transfer level description of said electronic device design.

11. A computer program product, comprising a non-transistory computer readable medium having a series of operating instructions embodied therein, said series of operating instructions adapted to be executed to implement a method of designing an integrated circuit, the method comprising:
receiving a placement database of logic devices of an electronic device design, including first and second logic devices;
determining a first timing window associated with a first state transition of said first logic device, and a second timing window associated with a second state transition of said second logic device; and
in the event that said first and second timing windows overlap, modifying said placement database thereby reducing interaction of said first and second logic devices.

12. The computer program product as recited in claim 11, wherein said determining includes executing a static timing analysis of said placement database.

13. The computer program product as recited in claim 11, further comprising executing a second static timing analysis of said placement database subsequent to said modifying.

14. The computer program product as recited in claim 13, further comprising performing a gate-level simulation of said electronic device design after performing said second static timing analysis.

15. The computer program product as recited in claim 11, wherein said modifying includes at least one of:
adding a power supply decoupling capacitor near one or both of said first and second logic devices;
increasing a placement distance between said first and second logic devices; and
swapping said first or second logic devices with a third logic device in said placement database.

16. The computer program product as recited in claim 11, wherein said algorithm determines a coupling hazard risk zone that includes said first logic device.

17. The computer program product as recited in claim 16, wherein said algorithm reports a coupling hazard risk for said second logic device only when said second logic device is located within said coupling hazard risk zone of said first logic device.

18. The computer program product as recited in claim 11, wherein said modifying includes changing a register transfer level description of said electronics device design.

19. An electronic design automation system, comprising:
a hazard detection module configured to execute a computer-executed algorithm to determine from a placement database of logic devices of an electronic design a first timing window associated with a first state transition of a first logic device and a second timing window associated with a second state transition of a second logic device; and
a correction module configured to modify said placement database in the event that the first and second timing windows overlap, thereby reducing interaction of said first and second logic devices.

20. The system as recited in claim 19, further comprising a static timing analysis module configured to execute a static timing analysis of said electronic device design prior to said hazard detection determining said first and second timing windows.

21. The method as recited in claim 20, wherein said static timing analysis module is further configured to execute a static timing analysis of said electronic device design subsequent to said modifying.

22. The system as recited in claim 19, further comprising a gate level simulation module configured to execute a gate-level simulation of said electronic device design subsequent to said modifying.

23. The system as recited in claim 19, wherein modifying said placement database includes at least one of:
adding a power supply decoupling capacitor near one or both of said first and second logic devices;
increasing a placement distance between said first and second logic devices; and
swapping said first or second logic devices with a third logic device in said placement database.
